(19) United States
(12) Patent Application Publication
(10) Pub. No.: US 2006/0122880 A1
(43) Pub. Date: Jun. 8, 2006

(54) Method and system for performing a real estate closing on-line

(76) Inventors: Robert D. Franco, Baden, PA (US); Dean M. Trent, Pittsburgh, PA (US); John C. Ralston, Weirton, WV (US)

Correspondence Address: Pepper Hamilton LLP;One Mellon Center, 50th Floor, 500 Grant Street, Pittsburgh, PA, 15219, US

(21) Appl. No.: 11/006,142

(22) Filed: Dec. 7, 2004

(51) Int. Cl. G07G 1/14; G06Q 30/00

(52) U.S. Cl. 705/14

(57) ABSTRACT

The present invention is directed to a method and system for performing real estate transactions on-line. The method may include the steps of scheduling a closing session; viewing closing documents during the closing session on a user's computer; acknowledging each closing document viewed during the closing session; and/or completing closing by having a closing company representative sign closing documents on behalf of the user upon receipt of an executed Power of Attorney.

### TECHNICAL FIELD

The present invention relates generally to a method and system of preparing and managing real estate transfers and financing. In particular, the method and system generally allows for the preparation, execution, delivery and storage of relevant documentation and the data contained therein for a real estate closing.

### BACKGROUND

The process of buying, selling or even just financing real estate generally involves a great deal of documentation. Most of the documentation involved requires redundant personal information and signatures of the parties. What is more, the financing involved in real estate transactions can include lengthy applications that often need to be completed more than once if financing is being sought from more than one potential lender.

Another aspect of real estate transactions involves the scheduling and coordination of the parties and finances involved. This generally includes buyers, sellers, attorneys, real estate settlement providers, real estate agents, financial institution representatives, and others. All these people need to schedule a mutually convenient meeting time and place for the closing.

Also, a reconciliation of funds being transferred between parties must be coordinated so that the closing will be funded properly. Many different real estate professionals, branches of government and others must be paid at or near the closing date. This whole process is often made difficult by last minute adjustments in the agreed upon loan rates, taxes due and other variables.

Real estate transactions are further complicated by the fact that much of the information contained in the required documentation is often transferred or translated manually from the forms that were completed by hand to an electronic medium such as a computer. The involved real estate attorney, real estate settlement provider, realty company, title company or financial institution often does such a transfer. The information, once stored in electronic form, can then be delivered to mortgage banks, financial institutions, government sponsored agencies, or document custodians, or it can even be used by word processing software for completing the forms and documentation needed in “closing” the real estate transaction. Not only is this manual transfer or translation of data cumbersome, but also it is time consuming and prone to typographical and other errors.

Once the mortgage transaction is closed, copies of the final documents are usually stored or maintained by the attorneys, mortgage banks, financial institutions, and document custodians involved in the real estate transaction. The sheer bulk of the papers imposes significant storage costs to the professionals involved. This cost can be further exaggerated when copies of the documentation are translated to microfiche, scanned to electronic format or other means of long-term mass document storage.

What is more, the information obtained during the real estate transaction is very valuable to professionals regularly involved in these transactions. This information includes detailed demographic data about the parties. Professionals often use such information for marketing or follow-up promotions of their goods or services. Also, the non-confidential aspects of this information can be sold or traded to companies that collect consumer data. For this reason, it is important that certain parts of the information collected be translated and stored in a database or any easy to use means of data storage and retrieval.

Currently, the majority of the real estate mortgage industry still uses very antiquated methods for preparing closing documents. The sale and financing of real estate has historically been associated with a great deal of paper documentation due to longstanding statutes and laws requiring written, signed and notarized documents for the legal transfer of land and to bind lenders and borrowers to the terms of fair loan agreements. Most often, typewriters or even word processors are used, but the completed documents are not stored electronically. Also, during the process of generating the necessary documents, much of the data is repeated throughout the documents. Such repetition wastes time and is prone to human error.

Some companies have developed more sophisticated methods of preparing mortgage documents and handling the data needed for this process. For example, EDS™ (Electronic Data Systems Corp.) has developed what it calls the Accelerated Closing and Delivery Services (ACDS). This system is designed to handle and transfer mortgage closing data, while reducing or even eliminating the amount of paper needed for a mortgage closing. Using this system, a lender, attorney or other mortgage facilitator will scan, fax or transfer the handwritten or typed completed application papers to the company (EDS). The company processes and compiles the information from the application papers and generates electronic versions of the closing documents. Before or during a closing, a facilitator can access ACDS by modem or dedicated phone line to review this information. This system is accessed using a computer that is connected to the company's electronic image repository. At the closing table, the parties can visually inspect the closing documents displayed on a computer monitor. What is more, ACDS uses well-known signature digitizer pads to add party signatures to the closing documents. Hard copies of all documents can then be generated or the parties can be given a computer diskette, which contains the visual image of the closing documents.

However, even systems like ACDS, which reduce some redundancies of data input and the amount of paper used in finalizing closing documents, do not provide many tools needed to facilitate real estate transactions for the professionals that work in this industry. Moreover, the use of digital signatures to record the documents is commonly not accepted by local or county governments. Therefore, digital signatures may not provide an effective process.

Accordingly, a need exists for an improved method and system to facilitate real estate closings.

### SUMMARY

The present invention is directed to a method and system that uses a computer and/or video display device to facilitate a real estate transaction. In illustrative embodiments, the steps may include scheduling an on-line closing session; performing an on-line closing session; providing a real-time presentation of closing documents to a user during the on-line closing session; providing a live video with the real-time presentation during the on-line closing session; and digitally recording the on-line closing session.

The method may also include the step of acknowledging each closing document prior to completion of the on-line closing session. Also, the user may execute a Power of Attorney providing a closing company representative authority to sign the closing documents on the user's behalf at the completion of the on-line closing session. The Power of Attorney may be executed by the user prior to, during or after conclusion of the on-line closing session and may include security means for verification. The digital recording may include real time recordal of visual and/or audio elements, and/or movement including sequence of documents viewed on a computer screen during the on-line closing session. The scheduling and the on-line closing session may utilize commonly known online meeting software.

In another embodiment, a method for performing a real estate transaction on-line includes scheduling a closing session; performing an on-line closing session; viewing closing documents during the closing session on a user's computer; acknowledging each closing document viewed during the closing session; and completing closing by having a closing company representative sign closing documents on behalf of the user upon receipt of an executed Power of Attorney. The Power of Attorney may be executed by the user and grants to a closing company representative authority to sign the closing documents on the user's behalf. The Power of Attorney may be loan specific. The Power of Attorney may include security means for verification and may be executed prior to or by the end of the closing session. The step of acknowledging each closing document may include having the user indicate ‘yes’, ‘no’, or ‘other’ in response to the user's acceptance of each closing document.

The method may further include the step of providing a real-time presentation of closing documents to a user during the on-line closing session. The method may also include the step of providing a live video with the real-time presentation during the on-line closing session. The method may also include the step of digitally recording the on-line closing session. The method may also include the steps of clearing a title prior to scheduling the on-line closing session and/or providing control of the on-line closing session to the closing company representative.

### BRIEF DESCRIPTION OF THE DRAWINGS

FIG. 1 is a process flow diagram illustrating an embodiment of the method of the present invention.

FIG. 2 is a process flow diagram illustrating an embodiment of an on-line closing session in accordance with the method of the present invention.

FIG. 3 is a block diagram of exemplary internal hardware that may be used to contain or implement the program instructions of a system embodiment of the present invention.

### DETAILED DESCRIPTION

Illustrative embodiments of the invention may use a computer software package to facilitate and enable the primary features of the present invention. The software may include a basic word processing program such as Microsoft Word®, a database program such as Microsoft Access®, Fox Pro® or Visual Basic®, and a system for providing data entry, such as computer terminals with keyboards, document scanners, etc. While the present invention will be described herein as using an online meeting system such as WebEx or Intranets.com, other on-line meeting systems may be utilized as well. Real estate professionals, such as attorneys, settlement agents, title companies and financial institutions and others may use this method and system.

While the method of the real estate closing is described hereinafter in detail, the order or sequence of the steps may vary and may be performed in any manner as practiced and understood by one skilled in the art.

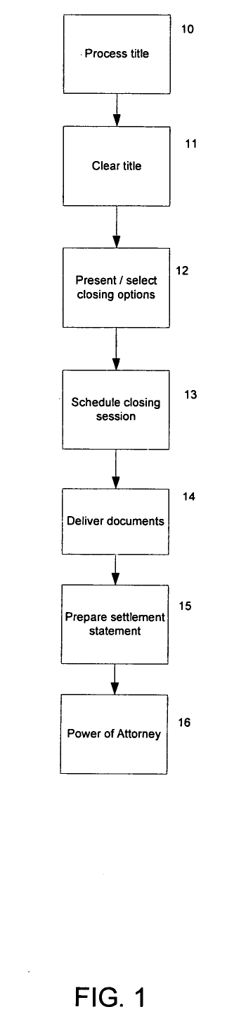

One embodiment of the present inventive method is illustrated in FIG. 1. Referring to FIG. 1, a step that may occur early in an embodiment of the method of the present invention is that of title processing 10. Initially, a lender or other may enter a loan application in a system utilized by an entity such as a desired title or closing company thereby notifying the provider of a potential closing. In the title processing step, documents may be received from the lender, and a title search for the loan application identifying a particular piece of property may be performed. A title delivery step may occur, where a commitment to insure from the title company is received.

The method may also include an up-front title clearance 11. During this step, items such as loans, encumbrances, etc., are cleared on the title commitment. This step generally occurs over the telephone and includes an information gathering step. For example, pay off demands may be ordered or leases may be secured. This step may also occur simultaneously with the title completion process.

At this time or at any time earlier in the process, the borrower may be provided with a choice in closing options 12. The fee structure may be explained to the borrower who is then directed to or decides on a model, such as the most cost-effective model. For example, the borrower may choose to perform a traditional closing, with a face-to-face meeting at a given location which in turn includes a higher closing/transaction fee. Alternatively, if a borrower meets criteria, for example, such as having high speed internet connectivity, an email account, a phone and internet line that may be used simultaneously, and/or other criteria, the borrower may choose the method and system of the present invention which may include a lower fee, as lower fixed expenses and overhead by performing the closing via the Internet, as well as increased scheduling flexibility may result.

A scheduling request may be received by the title or closing company or other provider from the lender for scheduling a closing date 13. The borrower is also contacted by the title or closing company to determine a preferred date and time for the on-line closing to be performed. The closing is preferably scheduled against the system's internal calendar, using an online meeting system such as WebEx, Intranets.com or another appropriate system. The online meeting system may include management tools to facilitate scheduling. The web process, including logins and site information, may be explained to the borrower. For example, the borrower may be provided with a review of the web closing process and then emailed a login, password, and client number to be utilized for the on-line closing. The borrower may also be provided with an email link that directs the borrower to a specific communications site, such as a web site, for the closing session. Additionally, a toll-free or toll telephone number may be provided so that the borrower may call in while simultaneously viewing the documents on the web during the closing session. The telephone line may be recorded so that audio recordings can be obtained for recordation and documentation purposes for the title or closing company as well as for the borrower. In an embodiment, the borrower, closing agent, and/or lender may use video communication services, and the video portion of the transaction may be recorded as well.

The lender may deliver documents 14 by providing the title or closing company with the loan documents which are then converted to preferably a portable document format or any other such suitable format and scanned in and prepared for use in the web-based closing. Documents may be delivered in any manner selected by the borrower such as email, overnight delivery or fax.

A settlement statement is prepared 15. During this step, a word processor or commercial software, such as that available from SoftPro, for example, may be utilized for preparation of the settlement statement (such as that commonly referred to as a HUD-1). The HUD-1 may be provided with a three day rescission notice or other period as provided by the law. For example, the law may require a three day cooling off period for primary residence purchases so that the borrower has the opportunity to change his or her mind and back out of the transaction before the loan is consummated.

The HUD-1 may then be converted over to a portable document format or similar format to correspond with the format of the other loan documents. The lender documents and the title or closing company documents may be combined into and forwarded as one or more files to a central location in preparation of the closing. Copies of the completed loan documents may be forwarded to the borrower prior to closing. This may be done via postal mail or any other delivery method desired, such as email. By receiving the loan documents prior to closing, the borrower may have an opportunity to review the materials for accuracy. Additionally, if Internet access is not possible at the scheduled date and time of closing, the hard copies of the loan documents are within the borrower's possession thereby allowing the closing to still occur by mail. At this time, the file is generally ready for closing.

In an embodiment, the method of the present invention may use a Power of Attorney from the borrower 16. The Power of Attorney may be general or limited in nature, for example, loan specific, and authorizes a specified representative from the title or closing company or other organization to act and/or sign closing documents on the borrower's behalf. The Power of Attorney may be executed by the borrower prior to or immediately at the conclusion of the on-line closing session. For example, the Power of Attorney for execution may be provided initially to the borrower with other corresponding documents such as a good faith estimate or may be provided at any time prior to the on-line closing session or even at the conclusion of such. Upon borrower's execution of the Power of Attorney, the Power of Attorney may be returned to the title or closing company. The title or closing company representative may then sign the physical original hard copies of the closing documents on behalf of the borrower at the conclusion of the on-line closing session. Therefore, an embodiment of the method of the present invention provides for an on-line closing while resulting in physically signed closing documents. The Power of Attorney preferably includes a form of security associated with it. The form of security allows for verification at the on-line closing session or conclusion thereof that the same parties that appeared before the notary and executed the Power of Attorney are the same parties present during the web-based closing. Examples of security that may be used with the Power of Attorney include passwords, pin numbers, and the like.

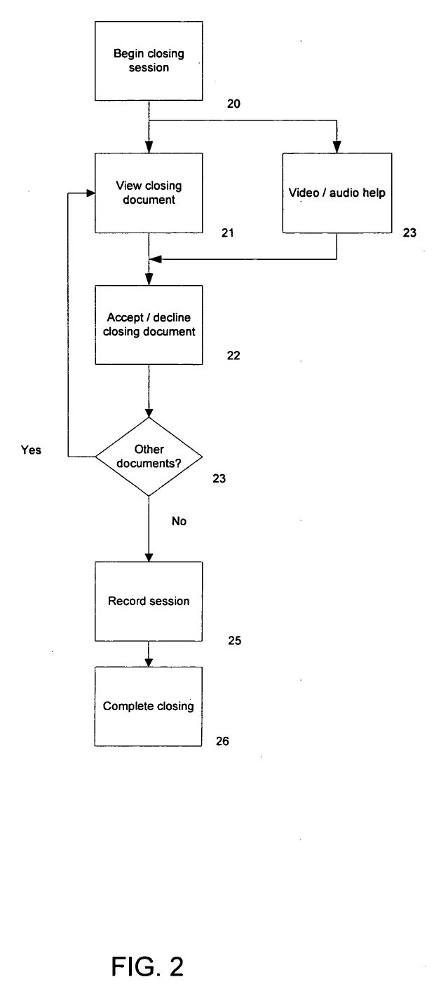

Referring to FIG. 2, at the prescribed time of the scheduled closing, a representative from the title or closing company logs into an online meeting session to host the closing meeting 20. The title or closing company representative proceeds to input all of the files with the closing documents and the loan documents into the meeting session and awaits the borrower's arrival. The borrower may then arrive and log in to the provided website. An opportunity will also be given for any ancillary representatives that may need to be present during the closing to log in. After verification of the necessary parties as being present, recordation of the audio, video and annotations on the screen of the closing session may be initiated 25.

Prior to the beginning of each session, after inputting the password and login by the borrower a demonstration of the process for explanatory purposes may be provided to acclimate the borrower to the on-line closing process of the present invention. A disclaimer may come up on the computer screen where the borrower is asked to accept and agree to the fact that the demonstration that they are about to go through does not constitute the actual closing or consummation of their loan. The disclaimer may also state that the borrower understands that the actions taken during the closing session are recorded and that the loan may not be consummated until the Power of Attorney is returned to the title or closing company representative and is executed on their behalf.

During the on-line closing session, the borrower may see a format where a split screen on their computer monitor is displayed. One portion of the screen may be designated to list the documents associated with the borrower 21. Another portion of the screen may include a live video of the title or closing company representative 23. The borrower may also have a video camera which allows his/her image to be available to the title or closing company representative as well.

As indicated above, the title or closing company representative may control the closing session, taking the borrower through each document for explanatory purposes 23. The documents may be pulled up individually and flipped through for the borrower and other individuals providing them with an opportunity to review, scroll or view, the documents. The host may also have a list of or access to annotation tools that are standard on the online meeting service for highlighting or circling so that during the on-line closing session a portion of the document may be highlighted to facilitate review of the important information in the documents. For example, the interest rate or maturity date on the loan may be circled by the title or closing company representative so that the borrower on the other end may quickly identify the value or terms in the document to check for accuracy, for example, while following along as the documents are presented.

Additionally, the borrower may be on the phone or other communications receiving instructions while reviewing the documents on their computer screen simultaneously. Optionally, the communication may occur over the computer via a voice over Internet protocol. Thus, the borrower simultaneously obtains audio instructions for the on-line closing session while viewing the documents and seeing the title or closing representative on live video on their computer screen.

Control of the on-line closing session may also be given to the borrower, allowing him or her to review the documents completely, if necessary. When this occurs, the borrower may be allowed to review any of the documents at a desired place, pace or order of documents. The title or closing company representative may go through the individual documents, in particular the documents that may need special acknowledgement. The borrower may then be instructed to indicate his or her acceptance of the document by selecting a response, such as “yes” or “no”, to a question presented at the bottom of each document indicating that they agree to the terms and conditions of such document 22. In an embodiment, as each document appears on the screen, the borrower may be required to check “yes” or “no” with respect to their acceptance of the viewed document. Additionally, the borrower may have an option to select “other” in lieu of “yes” or “no”, in which case the borrower may be able to provide an explanation for not accepting or declining the document. The results of the borrower's acknowledgement may be submitted to the title or closing representative who can simultaneously review the borrower's responses during the on-line closing session to insure that all parties agree to the terms of the documents and closing is proceeding. Alternatively, the “yes” or “no” answers to each document may be made at the end of the closing session at which time the borrower is then provided with an opportunity to provide explanations for the “no” or “other” responses. This acknowledgment step then becomes the closing transaction and a title or closing company representative explains the requirements upon finalization of the loan. Optionally, if a Power of Attorney has not been executed as of yet, the borrower may be required to execute such at this time.

Optionally, during the on-line closing session, other services may be simultaneously provided. For example, such services may include obtaining instant approval on a title, an automated appraisal, as well as credit, tax and flood insurance within a matter of minutes. Another example may include determining if an automated underwriting model may be obtained. Within a few minutes, a live deal with corresponding documents may be initiated with a representative standing by for explanatory purposes. This would allow an individual to go from applying for a loan application to a closing in a matter of minutes. Thus, while the documents as well as the need for and function of the Power of Attorney may be explained to the individual concurrently, the actual closing date may be a few days, for example ten days, later. In this example, this would allow the individual ten days in which to have the Power of Attorney executed before a notary, as well as the title company to clear the title on the property as well as produce a finalized HUD-1 sheet. Generally, closing occurs so long as the individual agreed with the HUD-1 and the executed Power of Attorney is executed and returned to the title company.

Additionally, during the closing session, the audio, video and annotations on the borrower's computer screen may be recorded in an embodiment simultaneously 26. For example, a microphone, telephone, or other audio input may be hooked up to the computer through a recorder box or the like. As the borrower reviews the documents, with possible annotations on the documents, the recorder box records the notes or markings on the screen as well as sound, such as comments made or questions asked by the borrower that are picked up by the recorder box. The on-line meeting software may also be utilized for recording data. Recordation occurs live, such as video and not as screen shots. For example, if the borrower scrolls from page 5 of the closing document to page 3 of the documents and then returns to page 5, such order of events is recorded in its entirety. The on-line meeting software then also allows for the user, for example, the borrower or title or closing company representative, to play back the on-line closing session.

As the closing occurs, the borrower may also be prompted to enter a poll as individual documents are executed. The poll allows for feedback regarding the on-line closing process of the present invention. The poll may be in the form of a survey or any other related format. At the end of the closing session, the poll is submitted by the borrower thereby providing the title or closing company representative with the ability to record the borrower's responses.

At the conclusion of the on-line closing session, the title or closing company representative preferably explains the requirements necessary to finalize the borrower's loan 26. For example, such actions that may be necessary for finalizing the loan may include executing a Power of Attorney in the presence of a notary if not already done so, printing out an airbill, or overnighting the Power of Attorney with a copy of the borrower's drivers license during the rescission period identified in the HUD-1.

After the on-line session is concluded and upon receipt of the Power of Attorney from the borrower, the title or closing company representative then executes the original physical closing documents on behalf of the borrower, having the authority to do so from the executed Power of Attorney. A post-closing audit may also be performed during the execution stage. Copies of the final closing documents are then made and prepared for delivery to the borrower and the mortgage recording group. A copy of the Power of Attorney is preferably combined with the lenders package of documents, the deed of trust as well as the title or closing company's documents. The mortgage may then be sent out for recording, the closing package may then be sent to the lender. After the rescission period identified in the HUD-1 is satisfied, the file is then disbursed and the policy is issued.

In an alternate embodiment, instead of (or in addition to) using a power of attorney, the borrower may electronically sign the closing documents by providing a digital signature or other electronic identification through one of any commonly known digital signature or electronic identification methods. Suitable methods may include, and are not limited to, XML digital signatures, digital certificates, public/private key identification methods, biometric identification systems, electronic signature capture pads, and other methods. This alternate embodiment may be used, for example, in situations where the applicable municipal, governmental or other authority will accept such a digital signature or other identification method.

In another embodiment of the present invention, a multiple party transaction may occur. For example, the title or closing company may close on forty loans for a specific organization in one day with forty different closing agents. The method of the present invention allows for one on-line closing session, where all forty borrowers go to the web-session at a given time, at which point the title or closing company representative explains and describes one set of standard loan documents for that specific organization. The documents are preferably not described in specific details to any one borrower but rather are generally described identifying where important terms, such as the interest rate, may be located on the documents and the general meaning of each document. The borrowers may then be given an opportunity to ask for virtual help where a live individual would appear on their computer screen during the on-line closing session to help the borrower with specific information relating to his/her specific closing.

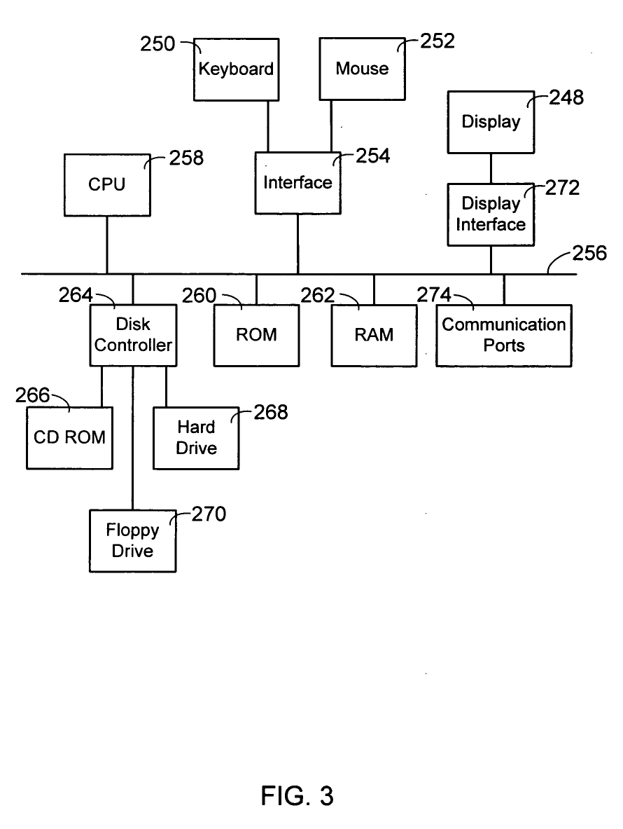

FIG. 3 is a block diagram of exemplary internal hardware that may be used to contain or implement the program instructions of a system embodiment of the present invention. Referring to FIG. 3, a bus 256 serves as the main information highway interconnecting the other illustrated components of the hardware. CPU 258 is the central processing unit of the system, performing calculations and logic operations required to execute a program. Read only memory (ROM) 260 and random access memory (RAM) 262 constitute exemplary memory devices.

Disk controller 264 interfaces one or more optional disk drives to system bus 256. These disk drives may be external or internal floppy disk drives such as 270, external or internal CD-ROM, CD-R, CD-RW or DVD drives such as 266, or external or internal hard drives 268. As indicated previously, these various disk drives and disk controllers are optional devices. Disk controller 264 may be any type of controller, known to those with skill in the art, including, but not limited to SCSI and IDE.

Each of the processes described herein are implemented as software modules or software applications, comprising program instructions stored in one or more of the disk drives connected to disk controller 264, ROM 260 and/or RAM 262. CPU 258 accesses these modules as required. Optionally, program instructions may be stored on removable computer readable media such as a floppy disk, CD-ROM, DVD-ROM, Flash memory cards, or other digital recording medium. Program instructions may also be transmitted to the hardware system by a communications signal or a carrier wave, through a wired or wireless medium.

A display interface 272 may permit information from the bus 256 to be displayed on the display 248 in audio, graphic or alphanumeric format. Communication with external devices may optionally occur using various communication ports such as 274.

In addition to the standard computer-type components, the hardware may also include data input devices such as a keyboard 250 or pointing input devices 252 such as a remote control, pointer, mouse and/or joystick.

As such, those skilled in the art will appreciate that the conception upon which this disclosure is based may readily be utilized as a basis for the designing of other structures, methods and systems for carrying out the several purposes of the present invention.

While the present invention is satisfied by embodiments in many different forms, there is described herein in detail, the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing from the scope and spirit of the invention. The scope of the invention will be measured by the appended claims and their equivalents.

What is claimed is:

1. A method for using a computer to facilitate a real estate transaction comprising:
scheduling an on-line closing session;
performing the on-line closing session;
providing a real-time presentation of closing documents to a user during the on-line closing session;
providing a live video of a closing company representative with the real-time presentation during the on-line closing session; and
digitally recording the on-line closing session.

2. The method according to claim 1, further comprising the step of acknowledging each closing document prior to completion of the on-line closing session.

3. The method according to claim 1, further comprising the step of the user executing a Power of Attorney providing a closing company representative authority to sign the closing documents on the user's behalf.

4. The method of claim 3, wherein the Power of Attorney is executed prior to or by conclusion of the on-line closing session.

5. The method of claim 4, wherein the Power of Attorney comprises security means for verification.

6. The method according to claim 1, wherein the digital recording comprises real time recordal of verbal sounds made and movement on a computer screen during the on-line closing session.

7. The method according to claim 1, wherein the closing company representative controls the real-time presentation of the closing documents.

8. The method according to claim 1, wherein scheduling and the on-line closing session utilizes an on-line meeting software.

9. A method for performing a real estate transaction on-line, comprising:
scheduling a closing session;
performing the closing session;
viewing closing documents during the closing session on a user's computer;
acknowledging each closing document viewed during the closing session; and
completing closing by having a closing company representative sign closing documents on behalf of the user upon receipt of an executed Power of Attorney, wherein the Power of Attorney is executed by the user granting a closing company representative authority to sign the closing documents on the user's behalf.

10. The method according to claim 9, wherein the Power of Attorney is loan specific.

11. The method according to claim 9, wherein the Power of Attorney comprises security means for verification.

12. The method according to claim 9, wherein the Power of Attorney is executed prior to or by the end of the closing session.

13. The method according to claim 9, further comprising the steps of:
providing a real-time presentation of closing documents to the user during the closing session; and
providing a live video with the real-time presentation during the closing session.

14. The method according to claim 9, further comprising the step of digitally recording the on-line closing session.

15. The method according to claim 9, further comprising the steps of clearing a title prior to scheduling the on-line closing schedule.

16. The method according to claim 9, further comprising the step of providing control of the on-line closing session to the closing company representative.

17. The method according to claim 9, wherein the step of acknowledging each closing document further comprises having the user indicate ‘yes’, ‘no’, or ‘other’ in response to his acceptance of each closing document.

18. The method according to claim 9, wherein scheduling and the closing session utilizes an on-line meeting software.

19. A method for using a computer to facilitate an on-line real estate transaction comprising:
scheduling a closing session;
viewing closing documents during the closing session on a user's computer;
providing a real-time presentation of closing documents to a user during the closing session;
providing a live video of a closing company representative with the real-time presentation during the closing session, wherein the closing company representative explains the closing documents;
acknowledging each closing document viewed during the closing session;
digitally recording the on-line closing session; and
completing closing by having the closing company representative sign closing documents on behalf of the user upon receipt of an executed Power of Attorney, wherein the Power of Attorney is executed by the user granting a closing company representative authority to sign the closing documents on the user's behalf.
